(19) United States
(12) Patent Application Publication
(10) Pub. No.: US 2015/0260349 A1
(43) Pub. Date: Sep. 17, 2015

(54) Fluid Dosage System

(71) Applicant: NCH Corporation, Irving, TX (US)

(72) Inventor: Stephan Craig Westcott, Chesterfield (GB)

(21) Appl. No.: 14/424,613

(22) PCT Filed: Jul. 23, 2013
(86) PCT No.: PCT/GB2013/051958

§ 371 Date: Feb. 27, 2015

(30) Foreign Application Priority Data
Aug. 29, 2012 (GB) 1215393.8

(51) Int. Cl. F17D 3/12

(52) U.S. Cl. CPC F17D 3/12

(57) ABSTRACT

A fluid dosage system for tanks, suitable for use in locations which are remote from a reliable source of electricity. The dosage system is configured to be activated upon the flow of a fluid through a flow switch, and can be configured to deactivate after a period of inactivity.

### FIELD OF THE INVENTION

The present invention relates to an automatic fluid dosage system for tanks, particularly for use in remote locations.

### BACKGROUND

Tanks or bulk storage containers are used to store fluids, for example fuels, at remote locations for use periodically. They may, therefore, be left unused for long periods of time. Storage tanks will be refilled by a supplier of the raw material once the level gets below a specified level. For example, fuel storage tanks, which can typically hold between 10,000 and 50,000 litres of fuel, will be periodically refilled by a delivery tanker once there is less than, say, 2,000 litres left in the tank. They may be used to occasionally supply, for example, vehicles or machinery with fuel. Tanks are often located outside, in locations that may be isolated from a mains supply.

It may be desirable or necessary to add an additive to a tank or bulk container. One method of achieving this is to simply pour the required amount through an inlet to the tank, however, some additives are potentially hazardous (flammable, toxic, irritants, etc.) and depending on the quantities required, it may not be practical to perform this operation manually. Another option is to pump the required quantity into the tank. This will usually require access to a permanent source of power, and possibly also an operator to determine when the addition of the additive should begin. Although often located in isolation from a mains power supply, it may be possible to provide power using an alternative power source, such as a solar panel, or a wind turbine. These types of power supply are generally impractical (or prohibitively expensive) if required to provide large quantities of power, particularly over long periods of time.

In the event that it is desired to add a controlled dose of an additive to a tank, using an electronically controlled dosage system, it is advantageous to provide a system which does not rely on a constant source of power. It is also desirable to provide a system which is automatically activated or deactivated as required.

According to the present invention there is provided a fluid dosage system for a tank, comprising at least one fluid passage to the tank, a switching mechanism connected to the fluid passage, and a control system for controlling the addition of a component to the tank, where the switching mechanism is activated by fluid flow, and where the switching mechanism controls the power to the control system. The flow of a first fluid through the passage will pass the switching mechanism which will connect the system to the power source via an electrical circuit. The power supply can be automatically activated when the storage tank is refilled by the passing of fluid.

Preferably the system includes at least two passages, such as a fluid inlet to the tank and a fluid outlet from the tank. There may be more than one inlet and/or more than one outlet. In an embodiment with separate inlets and outlets, the flow switch is connected to the inlet passage. In an embodiment with a single fluid passage which serves as both an inlet to and an outlet from the tank, the flow switch is a one direction switch such that it is only activated by flow of fluid in to the tank and not by flow of fluid out of the tank. There may be an inlet capable of being used for solid addition.

The fluid dosing system described herein has the ability to deliver a measured dose of an additive to a main vessel, or to the inlet/outlet stream of a main vessel. The system comprises of a switching mechanism, for example, a flow switch or flow sensor, a latching relay, and an electrical circuit. Optionally, the dosing system further comprises a power source and a control system (such as a PLC—programmable logic controller). Any available source of power can be used. Optionally, a pump can be used to supply the additive. The dosing system is capable of being automatically activated when required, and automatically deactivated after use. The system can be left unused for extended periods of time and thereby not drawing power.

According to the disclosed embodiments, the control system may include a flow switch which is connected to a latching relay. When the fluid inlet valve is opened, the fluid flows into the tank, and switches the flow switch. This activates the latching relay, which is then fixed in the ‘on’ position and provides power to the control circuit and the pump (if used). A pre-determined amount of the additive is then supplied to the tank under the control of the control circuit. When the flow of the first fluid to the tank is terminated, the latching relay is switched to the ‘off’ position by the control system, possibly after a predetermined period of inactivity. The latching relay requires no power to remain in the position that it is switched to. Therefore power is only required by the switch when the latching relay switch is initially turned on/off. Alternatively, a reed switch or pressure switch can be used in conjunction with a transistor to control the power input to the control system in a similar manner. An alternative system could involve the use of a relay, which is electrically latched by the control circuit for example, by using an output from the PLC.

to The tank contains a bulk fluid, i.e. a first fluid, which may be a fuel, for example. The additive, which may be a solid or a second fluid, is stored in a separate vessel. There may be more than one additive. The fluid dosing system can be configured to activate upon delivery of additional quantities of the first fluid to the tank (e.g. a delivery of fuel). When the control circuit has been activated, the dosing system starts to deliver a dose of the additive. This dose can be delivered at a pre-determined rate. The delivery of the dose is also controlled by the flow switch (or a suitable alternative such as a pressure switch or reed switch), such that if the flow of the first fluid through the inlet/outlet stops, the dose of the additive is paused. The controller can be configured to automatically switch the control circuit off after the dose is completed.

Relays can be controlled by a low-power signal. A latching relay is also known as a “stay” relay, as when the current is switched off, the relay remains in its previous state. The latching relay switch only requires power for an instant, at the time that it switched from one position to another, and the relay contacts retain this setting across a power outage until the relay is switched again. The relay does not need a continuous current through the coils in order to maintain its operation. The latching relay works in a similar way to a conventional household light switch; a short burst of power is required to turn it on and another to turn it off. A regular relay can also be used in the same manner, for example, when a switching mechanism is activated, it can close a relay, which then provides power to a control circuit. The control circuit can, in turn, keep the relay in a latched state, for example via a PLC, until the control circuit switches itself by releasing the relay.

A flow switch is also a type of flow sensor. It is used to sense the flow or passage of a fluid through a valve contained within the switch. The valve sends an enhanced or decreased electrical signal which is then read by a switching unit. The switch can be used to switch the latching relay on or off. Rather than measuring flow, measurements of pressure can also be used to the same effect, in which case the flow switch is a pressure switch. For the purposes of describing the fluid dosing system, the terms flow switch and pressure switch should be understood to perform the same function and are therefore interchangeable.

An alternative system could involve the use of a reed switch in combination with a transistor (rather than a latching relay) connected to the control circuit to achieve the same net effect. A transistor is a semiconductor device which can be used to amplify and switch electronic signals and electrical power. As a transistor can amplify a signal, the output power can be higher than the input power. The transistor can therefore be controlled with a low-power signal.

Additives may be required for a number of reasons. Examples of possible reasons to add an additive to fuels are: to improve the injector cleanliness, to reduce foaming, to provide improved lubricity, to prevent the fuel forming an emulsion with contaminants such as water, to prevent corrosion, to improve engine performance/mileage, to improve engine starting in cold weather, to reduce clogging and to reduce harmful emissions and smoke. If the first fluid is a fluid other than fuel, an additive might be required to adjust the pH, to reduce/prevent bacterial growth, to reduce corrosion, to reduce foaming or to change other chemical or physical properties of the fluid. It may be desirable to add more than one additive. The percentage of additive required will depend on the additive itself and the effective concentrations. In most cases the properties of the additive and the intended use for the additive will dictate the percentage required. For example, in aqueous systems an additive that acts as a dispersant at low concentrations can become a cleaning or foaming agent at higher concentrations.

Examples of demand for a diesel supply from a tank include diesel automotive engines (for example, farm or military vehicles), auxiliary/emergency power engines, stand-alone engines, diesel-powered electrical systems, diesel compressors and marine engines. Other fluids may also be supplied on a similar, as-needed basis. The dosage system disclosed herein would be suitable for any bulk fluid which requires an additive, in a location isolated from a mains power supply.

A typical dosage system may comprise of a tank, with a fluid inlet and outlet. An embodiment of the invention involves using the delivery of a first fluid to the tank to activate a flow switch, such that an additive is added to the first fluid. Adding the additive to the inlet or outlet of the tank ensures that the additive is well mixed with the first fluid (through turbulent mixing), and that the correct ratio of additive to the first fluid is always maintained. Alternatively, a quantity of additive can be added directly to the first fluid in a tank.

A typical storage tank may provide storage for up to 50,000 litres of the first fluid, with typical deliveries to the tank comprising of up to approximately 32,000 litres at a time. These figures are provided for illustrative purposes only; it will be known to a person skilled in the art that the tank size and delivery volumes can be as large or as small as desired. Filling times are typically between 30 minutes and an hour, with a typical delivery flowrate being between 500 and 1,000 litres/min. If an additive concentration of 0.1% (for example) is required, then for a 32,000 litre delivery, approximately 32 litres of additive are required, which may take 10 minutes to add. This illustrates the relatively short required usage times for the additive dosage system.

The additive may be stored in a vessel of any size. Typically the additive is required in substantially smaller quantities than the first fluid and can be stored in a drum. The dosing system can be configured such that it is activated whenever a delivery of the first fluid occurs, which may mean that the system is typically used for under an hour, once per week.

Examples of the present invention will now be described, by way of example only, with reference to the accompanying diagrammatic drawings, in which:

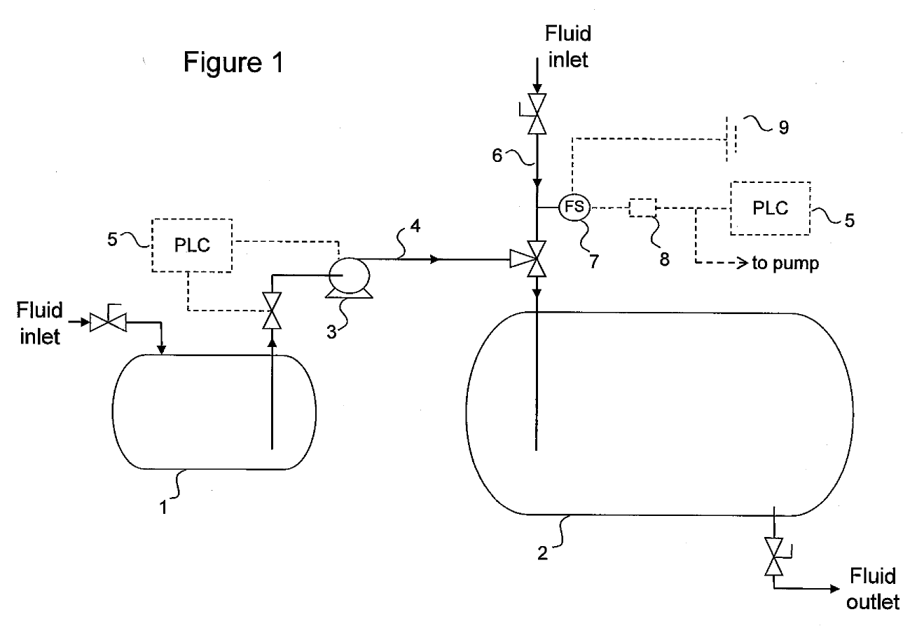

FIG. 1 is a flow diagram of one example of the automatic dosing system, where one additive is used;

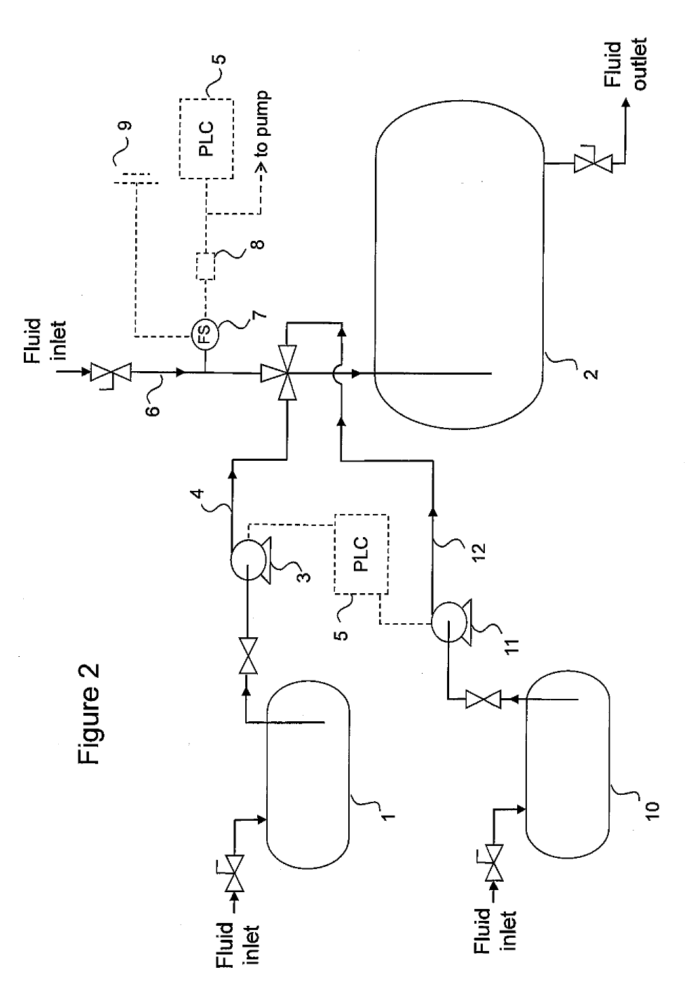

FIG. 2 is a flow diagram of a second example of the automatic dosing system, where two additives are used.

In FIG. 1, the additive is supplied from the additive drum 1 to the bulk storage tank 2 via pump 3, through line 4. The additive flow rate is controlled by the PLC control system 5. The PLC control system is connected to an electrical circuit. The power source is only connected to the electrical circuit when the flow switch 7 has been activated by an initial flow of a first fluid through line 6. The flow switch 7 switches the latching relay 8 to the ‘on’ position, thus providing power to the circuit, the PLC control system 5 and the pump 3. Any available power source 9 can be used. The PLC control system 5 may optionally be configured such that if the flow of the first fluid through the line 6 is stopped, a signal is sent from the flow switch 7 to an input on the PLC control system 5, which switches off the pump 3 until the flow of the first fluid resumes. The valves can be of any suitable type and do not necessarily need to be gate valves. Control valves can be used. The additive can be added at any point in the line 6 or directly into the tank 2, if preferred, and a three-way valve is not a requirement. A pump is optional, as a gravity-fed system, or other alternative mechanisms can be used instead.

FIG. 1 illustrates only one example of a possible system. Another option includes adding more than one additive. This may be conducted simultaneously or sequentially. More than one pump may be required, as well as more than one addition point.

FIG. 2 illustrates an example of a system where two additives are used, with both additives being supplied through the same inlet. In FIG. 2, the second additive is stored in drum 10, pumped through a second pump 11, through line 12 which connects to tank 2, through the use of inlet line 6. The line 12 can connect to fluid inlet line 6 at any point, and any suitable valve can be used. As mentioned above, the second additive could alternatively be added through a separate inlet to the tank 2. The second inlet could also be fitted with a switching mechanism, linked to an electrical circuit, a power source and a control system.

Pressure relief valves and instrumentation have been omitted from the diagrams for simplicity. The system could include flow measurement devices as part of the control loop; however, for simplicity only the initial flow switch has been included in the illustrated examples.

Many different control configurations can be used. The control system will normally include flow meters, control valves and can optionally include level sensors. The pump and control system can be fitted with an emergency stop button. The control system and PLC can be provided with a display screen, to assist with the configuration of the process variables. Alternatively, the PLC can be linked to a remote display screen. The system can be configured to deliver a set dose at a set rate or may be configured to deliver a predetermined amount of additive. For example, the amount of additive added at any one time may be a percentage of the flow rate of the first fluid, e.g. a variable flowrate, to maintain a constant percentage of additive even if the flowrate of the first fluid varies. Alternatively, the control system may be programmed to deliver a set flowrate of additive independent of the flowrate of the first fluid.

A further option is to supply the additive to the tank through the use of a gravity feed system instead of using a pump.

Another feature of the dosage system is to provide metering of the additive by continuously measuring the volume which is added to the storage tank. The control system can be provided with access to GSM (Global System for Mobile Communications) networks. The control system can be designed to track and record usage of the additive. By using GSM, data can be transmitted to a central location, such as a company's head-office. When the amount of additive has been depleted to a certain level, a sales representative can contact the customer to check whether further supplies are required, or alternatively, the customer can specify that they would like an automatic replacement when the additive is depleted below a specified level. The additive system can therefore be maintained and operated with minimal effort by the customer.

A lockable container, cupboard, case or equivalent storage facility can provide a safe, weather-proof storage location for the PLC and optionally for the additive drum and the pump. Once the control system has been configured, the settings can be stored on the control system and there will often be no need to make any further adjustments to the system. As the fluid dosage system operates automatically, there is no need for an operator to have access to the PLC. Upon delivery of the fluid for the bulk storage container (e.g. diesel), the additive dosing system will automatically ensure that the correct amount of additive is supplied to the tank. The additive dosing system does not require a dedicated operator, and the driver of the delivery tanker can refill the storage tank in the standard manner, without having to undertake any additional steps.

Refilling the bulk storage tank during, for example, a diesel delivery can be illustrated using FIG. 1. In order to perform the diesel delivery, the driver of the tanker would need to connect the supply hose from the tanker to the fluid inlet point on inlet line 6 and open the appropriate valves. The additive dosing system will automatically start to function when the diesel flows past the flow switch. The additive will be supplied from the additive drum 1, through pump 3, line 4 and line 6, to enter storage tank 2. When the appropriate amount of diesel has been delivered from the tanker (for example, 32,000 litres), the driver will shut the appropriate valves and disconnect the supply hose from line 6. The additive dosing system will automatically stop. When the fluid dosing system stops will depend on the programming of the control system, and may for example be due to the lack of flow through the inlet line 6, or alternatively the dosing system may have been programmed to stop after a certain volume of additive has been added to tank 2. It can be seen from this example that the driver does not need to undertake any additional steps over and above those ordinarily involved in a delivery.

The above examples have been described by way of example only, and the described examples are to be considered in all respects only as illustrative and not restrictive. It will be appreciated that variations of the described examples may be made without departing from the scope of the invention.

What is claimed is:

1. A fluid dosage system for a tank, comprising at least one fluid passage to the tank, a switching mechanism connected to the fluid passage, and a control system for controlling the addition of a component to the tank, where the switching mechanism is activated by fluid flow, and where the switching mechanism controls the power to the control system.

2. A fluid dosage system for a tank as claimed in claim 1, where the switching mechanism is a flow switch.

3. A fluid dosage system as claimed in claim 1, where the switching mechanism is a reed switch.

4. A fluid dosage system as claimed in claim 1, where the switching mechanism is a pressure switch.

5. A fluid dosage system as claimed in claim 1 where the switching mechanism is connected to a relay.

6. A fluid dosage system as claimed in claim 5, where the switching mechanism is connected to a latching relay.

7. A fluid dosage system as claimed in claim 6, where the latching relay is arranged to be electrically latched by the control circuit.

8. A fluid dosage system as claimed in claim 6, where the latching relay is arranged to be activated in response to a flow of fluid through the switching mechanism.

9. A fluid dosage system as claimed in claim 1, where the switching mechanism is connected to a transistor.

10. A fluid dosage system as claimed in claim 9, where the transistor is arranged to be activated in response to a flow of fluid through a switching mechanism.

11. A fluid dosage system as claimed in claim 1, where the tank is arranged to contain a first fluid and a second storage vessel is arranged to contain a second fluid, and where the switching mechanism is arranged to be activated in response to the flow of the first fluid.

12. A fluid dosage system as claimed in claim 1, in which there are at least two fluid passages to the tank.

13. A fluid dosage system as claimed in claim 1, in which there is at least one fluid inlet to the tank and at least one fluid outlet from the tank.

14. A fluid dosage system as claimed in claim 1, where the control system is connected to at least one pump.

15. A fluid dosage system as claimed in claim 1, where there is more than one switching mechanism.

16. A fluid dosage system as claimed in claim 1, where the control system is linked to a Global System for Mobile Communications (GSM) network.

17. A fluid dosage system as claimed in claim 1, where the control system is stored within a lockable container.

18. A fluid dosage system as claimed in claim 1, where the control system, pump and a storage vessel for a second fluid are stored within a lockable container.

19. A fluid dosage system as claimed in claim 1, where the control system is arranged to automatically deactivate in response to predetermined criteria.

20. A fluid dosage system as claimed in claim 19, where the control system is arranged to automatically deactivate in response to the cessation of flow of the first fluid.

21. A fluid dosage system as claimed in claim 19, where the control system is arranged to automatically deactivate after a set period of time.

22. A method of adding a second fluid to a tank, the method comprising utilising the flow of a first fluid to activate a switching mechanism, where the switching mechanism controls the power to a control system.

23. A method according to claim 22, the method comprising: passing a first fluid through an inlet line to the tank; said first fluid flow triggering a flow switch, activating the switching mechanism which completes an electrical circuit, providing power to a control system which activates a pump which supplies the second fluid to the tank

24. A method according to claim 23, where the switching mechanism is connected to a latching relay.

25. A method according to claim 23, where the switching mechanism is a reed switch.

26. A method according to claim 23, where the switching mechanism is a pressure switch.
